(19) United States
(12) Patent Application Publication
(10) Pub. No.: US 2024/0272881 A1
(43) Pub. Date: Aug. 15, 2024

(54) SYSTEM, METHOD AND COMPUTER PROGRAM FOR MANAGING FUNCTIONAL INTERFACE COMPONENT DESIGN IN APPLICATION BUILDER

(71) Applicant: Aquafadas S.A.S.U., Montpellier (FR)

(72) Inventors: Christelle DUCLOS, Montpellier (FR); Tiffany VISSOUZE, Montpellier (FR)

(73) Assignee: Aquafadas S.A.S.U., Montpellier (FR)

(21) Appl. No.: 18/167,122

(22) Filed: Feb. 10, 2023

(51) Int. Cl. G06F 8/38; G06F 8/20

(52) U.S. Cl. CPC G06F 8/38; G06F 8/20

(57) ABSTRACT

Provided are apparatus, system, method, and device for managing functional component design in low-code or no code app builders. The apparatus includes: at least one memory storage storing computer-executable instructions; and at least one processor communicatively coupled to the memory storage, wherein the at least one processor is configured to execute the computer-executable instructions to: present, to a user, a first graphical user interface (GUI) comprising information of a functional component, wherein the functional component is comprised of one or more sub-components; receive, from the user via the first GUI, a user input for managing a property associated with the one or more sub-components; manage the property associated with the one or more sub-components based on the user input; and updating the functional component based on the property

### BACKGROUND

### 1. Field

Apparatuses and methods consistent with example embodiments of the present disclosure relate to application builders, more particularly, to functional component design management in low-code or no-code application builders.

### 2. Description of Related Art

In the related art, a low-code or no-code application builder (referred to as “App builder” hereinbelow) is a platform or system which allows a user, who may not have experience or skill in coding, to build an App by, for example, configuring and selecting templates (e.g., pre-configured components, pre-defined stylistic design options, etc.) from a graphical user interface (GUI).

For instance, an App builder may include pre-configured functional components, such as but are not limited to buttons, sliders, and icons, so as to allow a user to build an application by, for example, drag-and-drop of desired functional components, with simplicity. In addition, some functional components may comprise one or more sub-components. In the example of a button, it may include but are not limited to a text label and an icon. Furthermore, such sub-components may be part of an object hierarchy. In said example of a button, the text label and the icon may be inside a viewing container, and the entire viewing container could be inside a touchable region. Such sub-components may be configured in order to allow the user to configure the design of the functional components. In said example of a button, the typography of the text label could be changed, and the dimensions of the viewing container and/or touchable region could be adjusted.

Nevertheless, as discussed hereinbelow, managing the design of the functional components in the related art App has many limitations and may be difficult for the user.

To begin with, in the related art, the selectable or available design configurations for the functional components (e.g., button size, button shape, etc.) are defined by a design charter provided by a specific user (e.g., developer of App builder, manager or system admin of App builder, etc.). Thus, the selectable design configurations of the functional components may be generic and the users of the App builder may have limited choice on the design of the functional components, which may be troublesome particularly when the user would like to have a specific appearance for the functional components applied when building an application with the App builder (e.g., a user wishes for a button to be a specific dimension while having rounded corners, but the App builder only has rounded corners when using a fixed dimension, etc.).

In case a user's desired design configuration for the functional component is not available, the user may need to (1) contact the provider of design charter and request the provider to modify the design charter (e.g., add new design configuration for the functional components, adjust the previously set design configurations for the functional components, etc.), or (2) modify the design charter by themselves to introduce or include the desired design configuration for the functional components.

In this regard, approach (1) may be time consuming since the to-and-fro communication between the user and the charter provider may be inefficient (e.g., charter provider may not quickly grasp the user's desired design requirement and may deliver incorrect charter changes at the first attempt, etc.) and may eventually causes delay in completion of the application building. On the other hand, approach (2) requires the user to have prerequisite knowledge and skills (e.g., knowledge on how to configure the design charter, coding skills, etc.). Further, said approach require the user to manually modify the design charter, which may introduce human error.

In addition, since the design charter may be utilized by all users in the related art App builder, an error made in the design charter can eventually affect all users (e.g., operational error caused by error in design charter is applicable to all users, etc.). Further, modification made by a user may not be intended by another user. For example, a first user may modify the design charter to modify a pre-defined design configuration for a functional component, but a second user may not want the pre-defined configuration for the functional component to be modified in the way the first user has done.

On the other hand, the user may want to share a specific pre-defined configuration of the functional component to only a specific group of users. For instance, a first user may want to share a button design 1 having a rounded corners to a second user, and may want to share another button design 2 having square corners to a third user, without intending the second user to view or utilize button design 2 to and/or without intending the third user to view or utilize button design 1. Nevertheless, in the related App builder, since the inclusion of a user's intended design configuration for the functional components are performed on the design charter (which is utilized among all users), it will be unduly difficult (if not impossible) for the user to share a specific design configuration for given functional component(s) to only a specific user(s).

Furthermore, in the related art, after modifying the design charter to adjust a design configuration for functional component(s), the user (e.g., the change requestor, the charter provider, etc.) may need to manually update all application design which has involved the old configuration of the functional component to appropriately reflect the adjusted design configuration for each functional component. For instance, a first user may have applied a button design 1 in 10 applications, and may modified the design charter to adjust a button corner style in button design 1. In that case, the first user may need to manually update the 10 applications (e.g., by modifying the source codes associated therewith) to reflect the adjusted button corner style therein. Such an approach is burdensome for the user, requires the user to have good knowledge and coding skills, and may easily introduce errors.

### SUMMARY

Example embodiments of the present disclosure provide a system, apparatus, and method for improving the introduction or inclusion of a user's desired functional component design in a low-code or no-code application builder. Further, example embodiments of the present disclosure may allow the user to easily customize, adjust, modify, and/or share a functional component, without affecting the design charter utilized by all users while avoiding disclosing the design option to non-associated users. Furthermore, example embodiments of the present disclosure may automatically reflect an update in a design whenever a user has modified or adjusted the associated functional component.

Ultimately, example embodiments of the present disclosure simplify the processes of and reduce the user's burden in managing functional component design in an App builder, provide a user friendly approach to include or adjust a design configuration for a functional component via one or more GUIs, improve operational stability by reducing human error, increase efficiency by omitting to-and-fro communication among users, automatically reflect user's update of functional component design in the associated applications or projects, and improve work efficiency while avoid leakage of sensitive information by allowing sharing of one or more functional component(s) among specific users.

According to embodiments, an apparatus including: at least one memory storage storing computer-executable instructions; and at least one processor communicatively coupled to the memory storage may be provided. The at least one processor may be configured to execute the computer-executable instructions to: present, to a user, a first graphical user interface (GUI) comprising information of a functional component, wherein the functional component is comprised of one or more sub-components; receive, from the user via the first GUI, a user input for managing a property associated with the one or more sub-components; manage the property associated with the one or more sub-components based on the user input; and updating the functional component based on the property.

The functional component may be one of a button, a slider, a column, a container, a text, a card, or a cell.

The one or more sub-components may be at least one or more of text, a touchable container, a viewable container, an image, a button, a picker, a text field, and an icon.

The at least one processor may be configured to execute the computer-executable instructions to present the first GUI by: obtaining at least one source design charter associated with the functional component; generating, based on the at least one design charter, a listing of properties including at least one property associated with the one or more sub-components predefined by the source design charter; generate, based on the listing of properties, the first GUI; and provide the first GUI to a user terminal associated with the user.

The first GUI may include a plurality of interactive elements, each of which is associated with an operation for managing the functional component, wherein the user input comprises a user interaction with at least one interactive element of the plurality of interactive elements. The at least one processor may be configured to execute the computer-executable instructions to manage the functional component by: determining, based on the user input, the operation associated with the interactive element with which the user has interacted; and performing the operation to manage the functional component.

The at least one processor may be further configured to execute the computer-executable instructions to manage the functional component by: based on determining that the operation is a creation of a new customized property associated with the one or more sub-components, present, to the user, a second GUI comprising one or more interactive elements for specifying the configuration of the new customized property associated with the one or more sub-components; receive, from the user via the second GUI, a user interaction with the one or more interactive elements; generate, based on the user interaction, a new customized design charter, wherein the new customized design charter defines the user-specified configuration of the new customized property associated with the one or more sub-components; update, based on the new customized design charter, the first GUI to include information associated with the new customized property associated with the one or more sub-components; and update, based on the new customized design charter, the first GUI to include information associated with the functional component as a result of the new customized property associated with the one or more sub-components.

The at least one processor may be further configured to execute the computer-executable instructions to manage the functional component by: based on determining that the operation is a modification of an existing customized property associated with the one or more sub-components, present, to the user, a second GUI comprising information associated with the existing customized property associated with the one or more sub-components and one or more interactive elements for modifying the existing customized property associated with the one or more sub-components; receive, from the user via the second GUI, a user interaction with the one or more interactive elements; update, based on the user interaction, a customized design charter associated with the existing customized property associated with the one or more sub-components, wherein the updated customized design charter defines a modified customized property associated with the one or more sub-components; and update, based on the updated customized design charter, the first GUI to include information associated with the modified customized property associated with the one or more sub-components; and update, based on the updated customized design charter, the first GUI to include information associated with the functional component as a result of the modified customized property.

The at least one processor may further be configured to execute the computer-executable instructions to manage the functional component by: based on determining that the operation is a sharing of the functional component, present, to the user, a second GUI comprising information associated with the functional component and one or more interactive elements for specifying at least one user to which the functional component should be shared; receive, from the user via the second GUI, a user interaction with the one or more interactive elements; obtain, based on the user interaction, at least one configuration profile associated with the at least one user; and update the at least one configuration profile to include an ID of a customized design charter associated with the functional component.

According to embodiments, a method may be performed by at least one processor. The method may comprise: presenting, to a user, a first graphical user interface (GUI) comprising information of a functional component, wherein the functional component is comprised of one or more sub-components; receiving, from the user via the first GUI, a user input for managing a property associated with the one or more sub-components; managing the property associated with the one or more sub-components based on the user input; and updating the functional component based on the property.

Presenting the first GUI may include: obtaining at least one source design charter associated with the functional component; generating, based on the at least one design charter, a listing of properties including at least one property associated with the one or more sub-components predefined by the source design charter; generate, based on the listing of properties, the first GUI; and provide the first GUI to a user terminal associated with the user.

The first GUI may include a plurality of interactive elements, each of which is associated with an operation for managing the functional component, wherein the user input comprises a user interaction with at least one interactive element of the plurality of interactive elements, and wherein managing the functional component may include: determining, based on the user input, the operation associated with the interactive element with which the user has interacted; and performing the operation to manage the functional component.

Managing the functional component may include, based on determining that the operation is a creation of a new customized property associated with the one or more sub-components, present, to the user, a second GUI comprising one or more interactive elements for specifying the configuration of the new customized property associated with the one or more sub-components; receive, from the user via the second GUI, a user interaction with the one or more interactive elements; generate, based on the user interaction, a new customized design charter, wherein the new customized design charter defines the user-specified configuration of the new customized property associated with the one or more sub-components; update, based on the new customized design charter, the first GUI to include information associated with the new customized property associated with the one or more sub-components; and update, based on the new customized design charter, the first GUI to include information associated with the functional component as a result of the new customized property associated with the one or more sub-components.

Managing the functional component may further comprise: based on determining that the operation is a modification of an existing customized property associated with the one or more sub-components, presenting, to the user, a second GUI comprising information associated with the existing customized property associated with the one or more sub-components and one or more interactive elements for modifying the existing customized property associated with the one or more sub-components; receiving, from the user via the second GUI, a user interaction with the one or more interactive elements; updating, based on the user interaction, a customized design charter associated with the existing customized property associated with the one or more sub-components, wherein the updated customized design charter defines a modified customized property associated with the one or more sub-components; and updating, based on the updated customized design charter, the first GUI to include information associated with the modified customized property associated with the one or more sub-components; and updating, based on the updated customized design charter, the first GUI to include information associated with the functional component as a result of the modified customized property.

Managing the functional component may further include based on determining that the operation is a sharing of the functional component, presenting, to the user, a second GUI comprising information associated with the functional component and one or more interactive elements for specifying at least one user to which the functional component should be shared; receiving, from the user via the second GUI, a user interaction with the one or more interactive elements; obtaining, based on the user interaction, at least one configuration profile associated with the at least one user; and updating the at least one configuration profile to include an ID of a customized design charter associated with the functional component.

According to embodiments, a non-transitory computer-readable recording medium having recorded thereon instructions executable by at least one processor to cause the at least one processor to perform a method including: presenting, to a user, a first graphical user interface (GUI) comprising information of a functional component, wherein the functional component is comprised of one or more sub-components; receiving, from the user via the first GUI, a user input for managing a property associated with the one or more sub-components; managing the property associated with the one or more sub-components based on the user input; and updating the functional component based on the property.

Presenting the first GUI may include obtaining at least one source design charter associated with the functional component; generating, based on the at least one design charter, a listing of properties including at least one property associated with the one or more sub-components predefined by the source design charter; generate, based on the listing of properties, the first GUI; and provide the first GUI to a user terminal associated with the user.

The first GUI may include a plurality of interactive elements, each of which is associated with an operation for managing the functional component, wherein the user input comprises a user interaction with at least one interactive element of the plurality of interactive elements, and wherein managing the functional component includes: determining, based on the user input, the operation associated with the interactive element with which the user has interacted; and performing the operation to manage the functional component.

Managing the functional component may include: based on determining that the operation is a creation of a new customized property associated with the one or more sub-components, present, to the user, a second GUI comprising one or more interactive elements for specifying the configuration of the new customized property associated with the one or more sub-components; receive, from the user via the second GUI, a user interaction with the one or more interactive elements; generate, based on the user interaction, a new customized design charter, wherein the new customized design charter defines the user-specified configuration of the new customized property associated with the one or more sub-components; update, based on the new customized design charter, the first GUI to include information associated with the new customized property associated with the one or more sub-components; and update, based on the new customized design charter, the first GUI to include information associated with the functional component as a result of the new customized property associated with the one or more sub-components.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of a system for managing functional component design in an application builder, according to one or more embodiments;

FIG. 2 illustrates a block diagram of an example method for managing customized design parameter(s) of one or more sub-components associated with a functional component, according to one or more embodiments;

FIG. 3 illustrates an example GUI for managing one or more customized design parameter(s) for a sub-component associated with the functional component, according to one or more examples;

FIG. 4 illustrates an example GUI for adding a first new customized design property for a functional component, according to one or more examples;

FIG. 5 illustrates an example of an updated GUI for managing one or more customized design parameter(s) for a sub-component associated with the functional component, according to one or more examples;

FIG. 6 illustrates an example GUI for a list of saved functional components, according to one or more examples;

FIG. 7 illustrates examples of customized design charters, according to one or more embodiments;

FIG. 8 illustrates an example of configuration profile, according to one or more embodiments;

FIG. 9 illustrates an example mapping of user ID and configuration profile ID, according to one or more embodiments;

FIG. 10 illustrates a block diagram of a method for managing sharing of a customized design configuration, according to one or more embodiments;

FIG. 11 illustrates an example of updated configuration profiles, according to one or more embodiments;

FIG. 12 illustrates a block diagram of a method for changing a customized design configuration, according to one or more embodiments;

FIG. 13 illustrates an example use case of changing a customized design configuration, according to one or more embodiment;

FIG. 14 illustrates another example use case of changing a customized design configuration, according to one or more embodiments;

FIG. 15 is a diagram of an example environment in which systems and/or methods, described herein, may be implemented; and

FIG. 16 is a diagram of example components of a device according to one or more embodiments;

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a system and method for improving the introduction or inclusion of a user's desired design configuration of a functional component in a low-code or no-code application builder (referred to as “App builder” hereinbelow). Specifically, the example embodiments allow the user to specify intended design requirements via one or more graphical user interfaces (GUIs), and a customized design configuration for one or more functional component and/or one or more sub-components will be automatically created based on the user's input therefrom.

According to an embodiment, a design charter associated with the customized design configuration (referred to as “customized charter” hereinafter) will be created, and all user's customization, adjustment, and modification on the customized design configuration will be made on the customized charter, without affecting the design charter utilized by all users (referred to as “source charter” hereinafter). Further, the user may share the customized design configuration with one or more associated users by allowing said one or more associated users to access or utilize the customized charter, while avoiding disclosing the customized design configuration to non-associated users.

Furthermore, the system and method of the example embodiments may automatically reflect an update in a design whenever a user has modified or adjusted the associated design configuration for a functional component. Specifically, whenever the user would like to adjust or update a design, the user may simply make such adjustment or update via one or more GUIs, and said adjustment or update would be automatically recorded in the associated design charter and will be automatically applied to the associated application(s) or project(s).

Ultimately, example embodiments of the present disclosure simplify the processes of and reduce the user's burden in managing functional component design in an App builder, provide a user friendly approach to include or adjust a design configuration for a functional component via one or more GUIs, improve operational stability by reducing human error, increase efficiency by omitting to-and-fro communication among users, automatically reflect user's update of functional component design in the associated applications or projects, and improve work efficiency while avoid leakage of sensitive information by allowing sharing of one or more functional component(s) among specific users.

### Functional Component Design Management

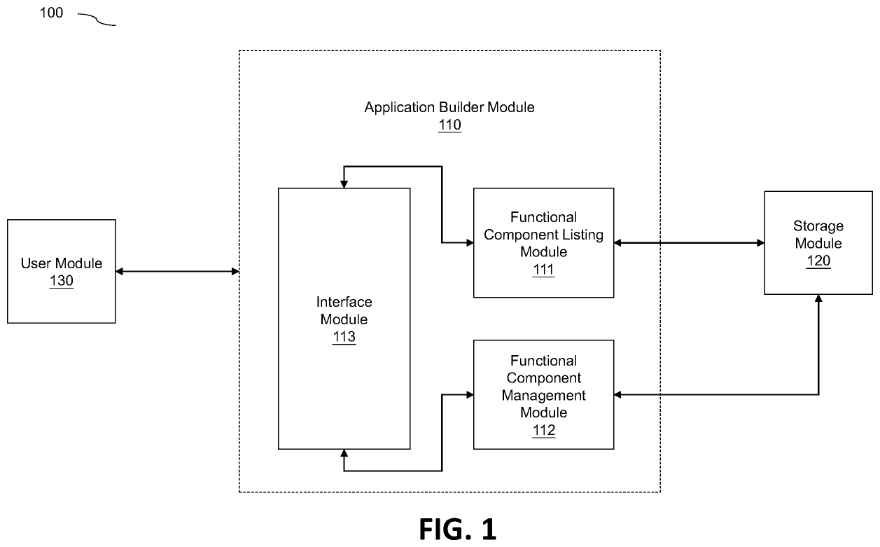

FIG. 1 illustrates a block diagram of a system 100 for managing functional component design in an application builder, according to one or more embodiments. For instance, system 100 may be utilized to create one or more customized functional components such as a button, slider, text, container, card, cell, image, icon, picker, text field, or any component which may be created using the application builder.

Referring to FIG. 1, system 100 may include an application builder (may be referred to as “App builder” hereinafter) 110, a storage module 120, and a user module 130 (may be respectively referred to as “module 110”, “module 120”, and “module 13” hereinafter).

The user module 130 may include any suitable module, device, or machine which enable a user to access and utilize an App builder via module 110. For instance, module 130 may include any type of computing, networking, or mobile device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including short-range ultra-high frequency (UHF) device, near-field communication (NFC) module, infrared (IR) module, controller area network (CAN) module, universal serial bus (USB) module, high definition multimedia interface (HDMI) module, a Bluetooth™ module, and Wi-Fi module, among others.

The storage module 120 may include any suitable storage medium, such as server, web storage, memory device, and the like, which may store data and information associated with the App builder, such as one or more design charters, one or more configuration profiles, user information, and the like. Further, storage module 120 may be implemented in a plurality of servers (e.g., a server cluster) in one location or in different locations. Furthermore, module 120 may include a plurality of sub-storages, each of which may be configured to store and provide different information. For instance, module 120 may include a first sub-storage for storing a design charter which may be utilized by all users of the App builder (referred to as “source charter” hereinafter), and may include a second sub-storage for storing a design charter which may be utilized only by one or more specific users (referred to as “customized charter” hereinafter).

The application builder 110 may include a functional component listing module 111, a functional component management module 112, and an interface module 113 (may be respectively referred to as “module 111”, “module 112”, and “module 113” hereinafter).

Interface module 113 may be configured to generate one or more graphical user interfaces (GUIs) and to present the generated GUIs to the user (via user module 130) to engage the user, to receive one or more user inputs from the presented GUI(s), and to provide the received one or more user inputs to one or more other modules (e.g., module 111, module 112, etc.) for further processing.

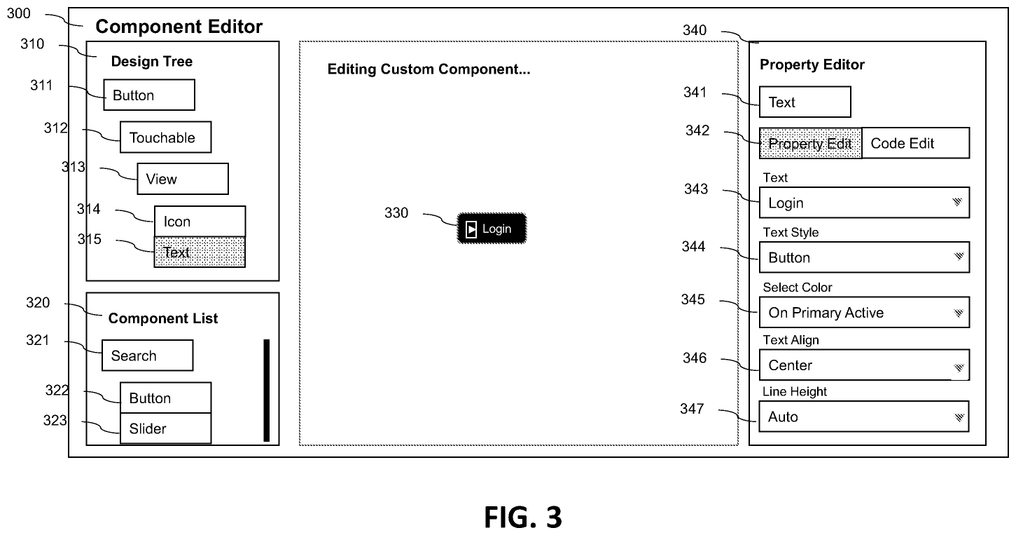

For instance, module 113 may generate a login GUI upon detecting an access from a non-login user, so as to allow the user to login to the system by inputting the associated credentials (e.g., user ID, password, etc.) via the login GUI. Further, upon successful login, module 113 may generate one or more GUIs to present available functional components (e.g., button, slider, text, container, card, cell, image, icon, picker, text field, or any component which may be created using the application builder, etc.) such that the user may select and utilize said functional components in building an application via the App builder. Furthermore, module 113 may generate one or more GUIs to guide the user and allow the user to specify, design, and create a customized functional component. Examples of one or more GUIs provided by module 113 are illustrated in FIG. 3 to FIG. 6.

Functional component listing module 111 may be configured to obtain one or more design charter(s) from module 120, and may be configured to generate a listing of available functional component(s) based therefrom. For instance, module 111 may be configured to receive user information (e.g., user ID) from module 113, to continuously (or periodically) obtain design charter(s) associated with the user based on the user information, to generate or update the listing of functional components available to the user based on the obtained design charter(s), and to provide the listing to the module 113. According to an embodiment, module 111 may first retrieve a configuration profile based on the user information, and may retrieve the one or more design charter(s) defined in the configuration profile. In this way, the listing of available functional component(s) may be updated continuously (or periodically) in real-time/near real-time, and the module 113 may always provide one or more GUIs including the updated availability of functional component(s).

Functional component management module 112 may be configured to manage one or more functional components. Specifically, module 112 may be communicatively coupled to the interface module 113 and a storage medium (e.g., storage module 120, etc.) and to manage (based on user input received and provided by module 113) one or more design charters each of which is associated with a respective customized functional component.

For instance, module 112 may be configured to receive user input from module 113 (e.g., user input received by the module 113 via one or more GUIs provided to the user for managing one or more functional components, etc.), and to manage a design charter associated with the user input (e.g., generate a new design charter if the user input is associated with creation or addition of a new customized functional component, update an existing design charter if the user input is associated with modification of an existing functional component, delete an existing design charter if the user input is associated with deletion or disabling of an existing functional component, etc.).

In this regard, module 113 may be configured to manager (e.g., generate, update, remove, etc.) one or more design charters pre-defined by another user such as provider of the App builder, system admin, design charter shared by said another user, etc., (may be referred to as “source charter” herein), one or more design charters associated with one or more functional components customized by the user (may be referred to as “customized charter” herein), and the associated information (e.g., configuration profile(s), information of associated user(s), etc.). Subsequently, the module 112 may be configured to store, retrieve, and/or remove the one or more design charters and the associated information from the storage medium.

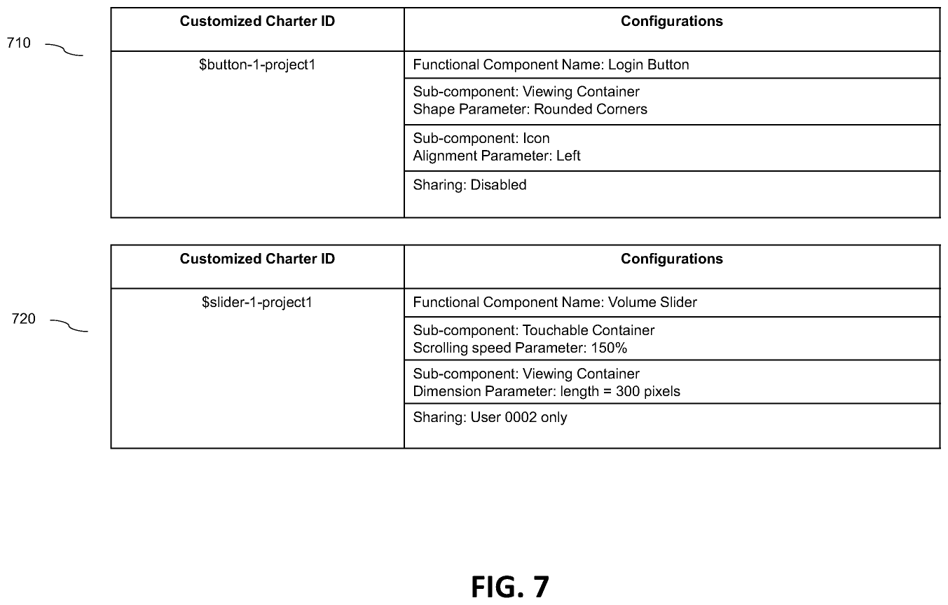

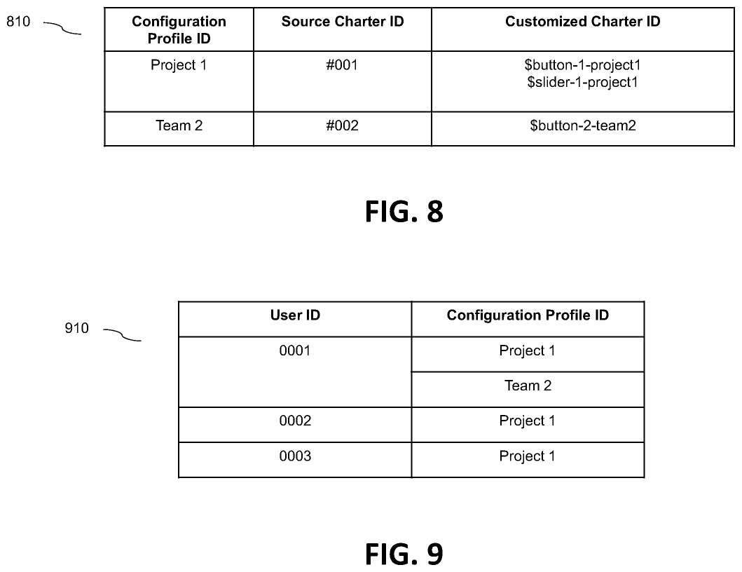

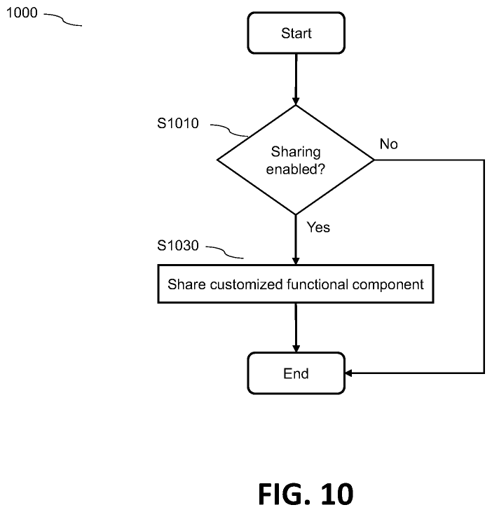

By way of example, module 112 may receive (from module 113) one or more user inputs defining an action to manage a customized functional component (e.g., creating a new customized functional component, updating an existing customized functional component, etc.), and generate a new customized design option (if the action is to create or add a new customized functional component) or update the associated customized design charter (if the action is to modify or adjust an existing customized functional component), based on the received user input(s). Accordingly, module 112 may generate or update information associated with the functional component, such as information in a customized charter (e.g., customized charter ID, configuration of customized functional component, etc.), information in a configuration profile (e.g., mapping of configuration profile ID and customized charter ID, etc.), and the like. Examples of customized design charter are described below with reference to FIG. 7, and examples of configuration profiles are described below with reference to FIG. 8, FIG. 9, and FIG. 10.

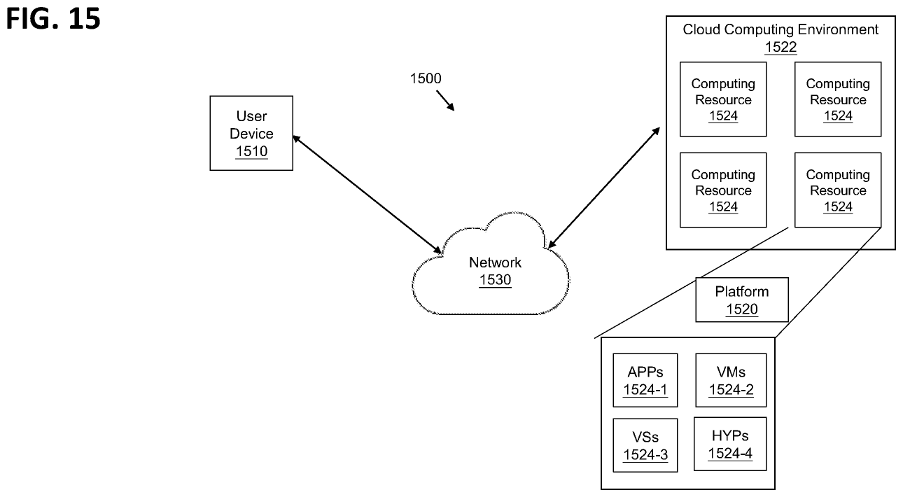

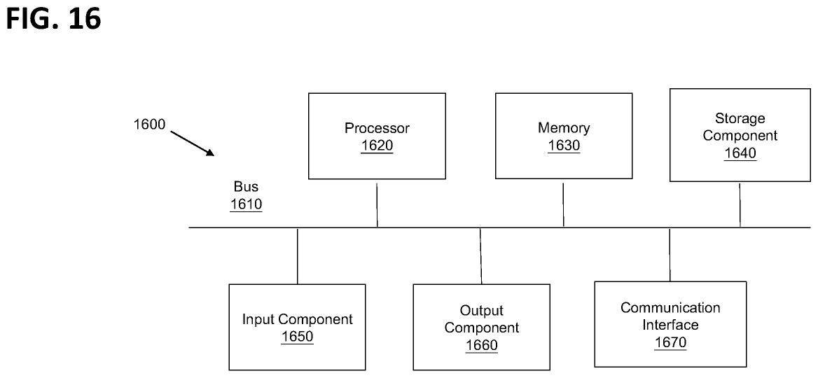

To this end, module 111, module 112, and module 113, in combination, may enable the user to easily manage and utilize one or more design options. One or more of module 110, module 120, and module 130 may be implemented in an environment described below with reference to FIG. 15, and may include one or more components described below with reference to FIG. 16.

Furthermore, it is contemplated that the configuration of system 100 may be arranged in a manner different from those described above, without departing from the scope of the present disclosure. For instance, system 100 may include more than one user module 130, App builder 110 may include additional modules, and the like. In addition, one or more of module 111, module 112, and module 113 may be combined to each other and function as one module. For example, module 111 and/or module 112 may be configured to perform one or more operations of module 113, module 111 and module 112 may be configured to perform one or more operations of one another, and the like. Further one or more of modules 111-113 may be deployed in the form of computer-readable or computer-executable instructions which, when being executed by at least one processor, cause the at least processor to perform one or more operations of said modules 111-113.

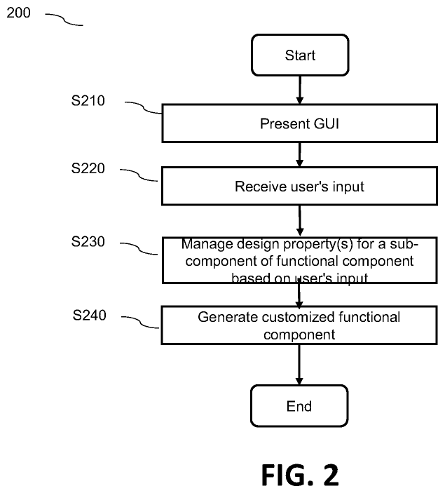

FIG. 2 illustrates an example block diagram of a method 200 for managing one or more customized functional components, according to one or more embodiments. Method 200 may be performed by App builder 110 (or one or more modules included therein) whenever a user would like to manage a functional component (e.g., add or create a customized functional component, modify or update an customized functional component, etc.), after the user has successfully login to the system.

Referring to FIG. 2, at operation S210, one or more GUIs are presented to a user. For instance, a GUI for managing the design configuration of one or more functional components may be presented to the user.

Specifically, the module 111 may be configured to: receive, from the interface module 113, user information (e.g., obtained by the module 113 during login process, etc.); obtain, from one or more storage mediums (e.g., storage module 120), one or more design charters associated with the functional component; generate, based on the received one or more design charters, a listing of available design properties associated with the one or more sub-components of the functional component (which are available to the user), and provide the listing to module 113. Accordingly, module 113 may generate and provide the GUI to user module 130, such that user module 130 may present said GUI to the user.

Assuming that there is no customized functional component available to the user (i.e., there is no customized charter associated with the user), module 111 may retrieve only source charter(s) associated with the user from the storage medium, and may generate a listing containing one or more design property(s) associated with the one or more sub-component(s) which are predefined by the source charter(s). Said pre-defined property(s) may be defined by, for example, the developer or admin of App builder 110, and may include one or more general design property(s) (e.g., frequently utilized design properties for each sub-component of each functional component etc.) applicable to all users of App builder 110. In this case, the first GUI presented to the user may include only the pre-defined design properties for the sub-component. For example, FIG. 3 may illustrate an example embodiment in which the GUI initially only contains pre-defined design properties for the sub-component (e.g., FIG. 3 may exemplify an embodiment in which default parameters related to a text sub-component of a default “login” button are provided). Further descriptions of the features in the GUI of FIG. 3 will be further provided below.

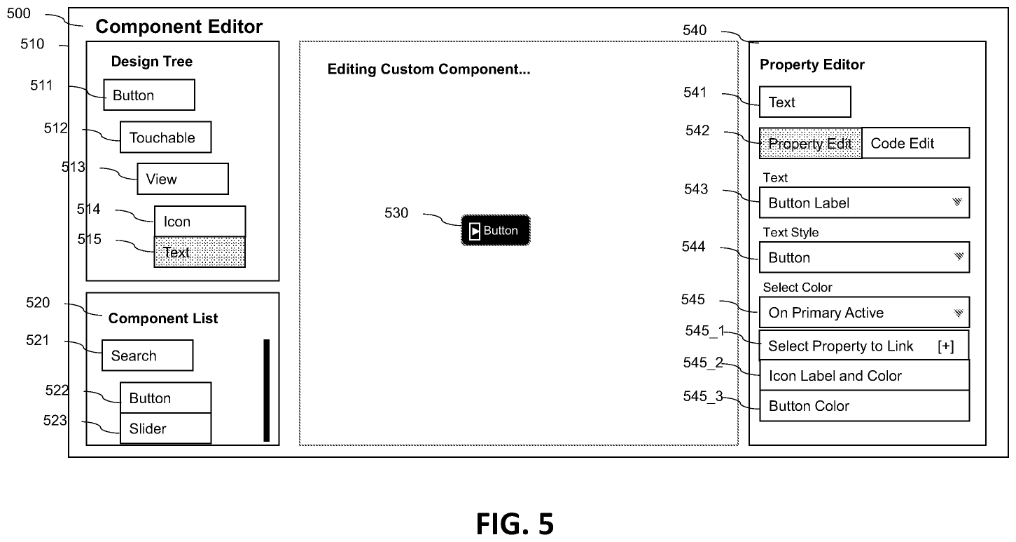

In other embodiments which there is one or more customized design property(s) for the associated sub-component of the functional component available to the user, module 111 may retrieve both source charter(s) and customized charter(s), and may generate a listing including design property(s) for the associated sub-component of the functional component defined by the source charter(s) and design property(s) for the associated sub-component of the functional component defined by the customized charter(s). Accordingly, module 111 may provide the listing to module 113, and module 113 may generate the first GUI which include information of design property(s) associated with both source charter(s) and customized charter(s). FIG. 5 exemplifies an embodiment in which the user may select between design properties which may include those which were pre-defined or newly added (i.e., customized). In this regard, FIG. 5 may be an updated version of the GUI of FIG. 3. Further descriptions of the features in the GUI of FIG. 5 will be further provided below.

Referring back to FIG. 2, at operation S220, one or more user inputs are received. Specifically, module 113 may receive one or more user interactions on one or more interactive elements of the presented GUI, wherein each the one or more interactive elements is associated with an operation for managing one or more customized design properties associated with one or more sub-components of the functional component. For instance, the user input may be a user interaction with an interactive element (e.g., a button, an icon, etc.) for creating or adding a new customized design property associated with one or more sub-components of the functional component, a user interaction with an interactive element (e.g., a button, an icon, etc.) for modifying an existing customized design property associated with one or more sub-components of the functional component, or a user interaction with an interactive element (e.g., a button, an icon, etc.) for deleting or removing an existing customized design property associated with one or more sub-components of the functional component.

Subsequently, at operation S230, the customized design property associated with one or more sub-components of the functional component associated with the user input may be managed based on the operation associated with the user input. According to an embodiment, upon receiving the user input, the module 113 may provide the user input to the module 112. Subsequently, module 112 may be configured to determine, based on the user input, an operation associated with the interactive element with which the user has interacted, and to perform the operation to manage (e.g., add, modify, delete, etc.) the customized design property associated with one or more sub-components of the functional component accordingly.

In an example embodiment in which there is no customized design property associated with one or more sub-components of the functional component available to the user and the user input is a user interaction (e.g., clicking, etc.) with the interactive element creating or adding a new design property associated with one or more sub-components of the functional component, one or more additional GUIs may be generated and presented to the user, so as to receive additional user input(s) for creating or adding the new customized design property associated with one or more sub-components of the functional component. In this example embodiment, the module 112 may determine that an operation for adding or creating a new customized design property associated with one or more sub-components of the functional component is triggered, based on determining that the user has interacted with the interactive element for creating or adding a new customized design property associated with one or more sub-components of the functional component. Subsequently, module 112 may notify module 113 such that module 113 may be configured to generate and present a second GUI for allowing the user to specify the configuration of the new customized design property associated with one or more sub-components of the functional component therefrom.

Alternatively, instead of simply forwarding the user input to module 112, module 113 may be configured to determine the operation associated with the interactive element with which the user has interacted, and may generate and present the second GUI accordingly, without departing from the scope of the present disclosure.

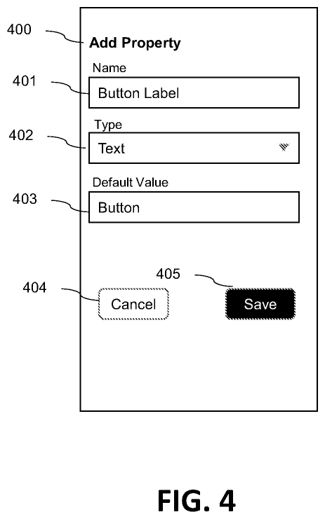

The second GUI may include a plurality of interactive elements (e.g., input fields, buttons, etc.) each of which is associated with a value for specifying the customized design property associated with one or more sub-components of the functional component, or is associated with a respective operation (e.g., creating, saving, cancelling the creation of the new design property associated with one or more sub-components of the functional component, etc.). Further, the second GUI may be presented in the form of a sub-window overlaying the first GUI described above in relation to operation S210. FIG. 4 exemplifies a GUI for adding a new customized design property associated with one or more sub-components of the functional component. In this regard, FIG. 4 illustrates an example GUI for adding a new design property associated with one or more sub-components of the functional component for an example text label property for a text sub-component. Further descriptions of the features in the GUI of FIG. 4 will be further provided below.

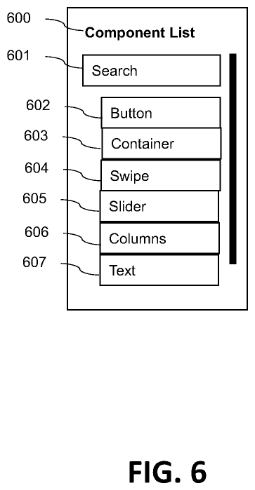

Referring back to FIG. 2, at operation S240 the App builder 110 (or one or more modules included therein) may update the GUI to save the designed overall functional component, including all the configurations of the design parameters of the sub-component(s) as a new customized functional component. For instance, the module 113 may provide the received user input(s) to module 112, module 112 may add the new customized functional component as a new customized charter or update the customized charter and associated configuration profile in module 120, depending on the user input in S220. Accordingly, module 111 may retrieve the design charters of all the available functional components (i.e., the source charter and the newly stored customized charter) from module 120, generate an updated listing of available functional components, and provide the updated listing to module 113. Subsequently, module 113 may generate an updated GUI including the updated customized functional components as well as any other pre-defined functional components, and present the same to the user (e.g., via user module 130). In this regard, FIG. 6 illustrates an example GUI for listing available functional components to be used in the App builder 110. Further descriptions of the features in the GUI of FIG. 6 will be further provided below.

In other embodiments in which customized design property(s) associated with one or more sub-components of the functional component are available, the user input may include one or more user interactions with one or more interactive elements (e.g., a button, an icon, etc.) for modifying, removing the existing customized design property(s) associated with one or more sub-components of the functional component, and the like. In that case, the module 113 may be configured to generate and provide the second GUI, which includes information associated with the existing customized design property(s) associated with one or more sub-components of the functional component and one or more interactive elements for modifying the existing customized design property(s) associated with one or more sub-components of the functional component. According to embodiments, the second GUI may be similar to the GUI illustrated in FIG. 4, with one or more parameters in the second GUI pre-populated or pre-filled by the system. For instance, based on determining that the user has interacted with an interactive element associated with an operation for modifying an existing customized design property associated with one or more sub-components of the functional component, the module 113 may obtain from module 111 information associated with the existing customized design property associated with one or more sub-components of the functional component (e.g., information included in design charter associated with the existing customized design property associated with one or more sub-components of the functional component, which is retrieved by module 111 when generating the listing of design property associated with one or more sub-components of the functional component at operation S210, etc.), and generate the second GUI based on the obtained information, wherein the second GUI may include one or more interactive elements pre-populated or pre-filled with one or more parameters defining the configuration of the existing customized design property associated with one or more sub-components of the functional component, such that the user may simply modify or adjust the configuration of the existing customized design property associated with one or more sub-components of the functional component, by interacting with the respective interactive element.

Accordingly, module 113 may be configured to receive one or more additional user inputs via the second GUI. For instance, module 113 may receive one or more user interactions with the one or more interactive elements included in the second GUI. Subsequently, module 113 may provide the received additional user input(s) to module 112, and module 112 may be configured to manage the associated customized design property associated with one or more sub-components of the functional component, based on the received additional user input(s).

In an embodiment in which the operation for managing the customized design property associated with one or more sub-components of the functional component is an operation for adding a new customized design property associated with one or more sub-components of the functional component, modification of an existing customized design property associated with one or more sub-components of the functional component, or deleting/removal of an existing customized design property associated with one or more sub-components of the functional component, the module 112 may be configured to update, based on the additional user input(s) received via the second GUI, a customized charter associated with the relevant customized functional component so as to include the user-modified configuration based on the adding, modifying, or removing of the customized design property associated with one or more sub-components of the functional component.

In yet another embodiment in which the operation for managing the functional component is an operation for sharing an existing customized functional component, the module 112 may be configured to obtain one or more configuration profiles each of which associated with one or more users to which the existing customized functional component should be shared (e.g., one or more users selected or specified by the user via the second GUI, etc.), and to update the one or more configuration profiles to include the information of the customized charter associated with the to-be shared customized design option.

In view of the above, example embodiments of the present disclosure allow a user to easily manage one or more design properties associated with one or more sub-components of the functional component, so as to allow the functional components to be customized for use in the design charter. Specifically, the process of managing the functional components and the related design property(s) of the sub-component(s) (e.g., adding, modifying, removing, etc.) can be performed directly by the user via one or more GUIs to fulfill a specific requirement, without involvement of other users (e.g., provider of source charter, admin of App builder, etc.). Accordingly, to-and-fro communication among multiple users may be avoided, and the efficiency and effectiveness of managing the functional component(s) may be improved. Further, since the process of managing the functional component(s) is performed via one or more GUIs, inexperience user may easily manage the functional component(s) and the risk of introducing errors during the management of design option(s) may be reduced.

### Graphical User Interfaces (GUIs) of Example Embodiments

As discussed above with reference to FIG. 2, the App builder (or one or more modules included therein) may generate and present one or more graphical user interfaces (GUIs) which allow a user to manage the functional components and the associated design properties(s) of the sub-component(s) of the functional components therefrom. Further descriptions of the associated GUIs will be provided hereinbelow.

FIG. 3 to FIG. 5, illustrate example GUIs presented to a user for managing one or more design properties of sub-components (e.g., text) associated with a functional component (e.g., a button), according to one or more embodiments. Specifically, FIG. 3 illustrates an example GUI 300 for managing design properties of sub-components associated with a functional component. FIG. 4 illustrates an example GUI 400 for adding a new customized design property of one of the sub-components associated with the functional component; and FIG. 5 illustrates an example GUI 500 which may be an updated version of GUI 300 including the customized design option added via GUI 400.

As illustrated in FIG. 3, GUI 300 may include a first partition 310, a second partition 320, a third partition 330, and a fourth partition 340.

The first partition 310 may include a listing of the sub-components associated with the functional component that is being managed. In the example illustrated in FIG. 3, first block element 311 may represent the functional component and is associated with the name of the functional component. Second block element 312, third block element 313, fourth block element 314, and fifth block element 315 represent sub-components respectively. The listing of block elements 312, 313, 314, and 315 may be arranged in a hierarchy relative to the first block element. In the example illustrated in FIG. 3, said block elements are arranged in a design tree in first partition 310. The user may opt to select each sub-component by interacting (e.g., clicking with a mouse, pressing a key on a keyboard, etc.) with the respective block element.

According to an embodiment, the block element associated with the sub-component selected by the user may be presented in a distinguishing manner (e.g., highlighted, filled with a pattern, etc.) from other block elements. For instance, in the example illustrated in FIG. 3, the user has selected to manage the design property(s) of the sub-component “text”. thus the associated block element 315 is filled with diagonal lines. Subsequently, based on the selected sub-component, the App builder (or one or more modules included therein) may update the fourth partition 340 of GUI 300 to list the property editor associated with the sub-component “text”.

The second partition 320 may include a listing of the available functional components which may include, but are not limited to those which have been either customized by the user, or predefined by the system administrator. According to an embodiment, each available functional component may be presented in a respective block element. For instance, in the example embodiment illustrated in FIG. 3, the available functional components are represented by block element 322, and block element 323. In some embodiments, the user may interact with block elements 322 and block element 323 in the App builder (or one or more modules included therein) to add one or more of the available functional component(s) into the app (for instance, by drag and drop). According to an embodiment, the user may also search through the listing of available functional components in partition 320. In the example embodiment illustrated in FIG. 3, the user may enter a user input, for example, by entering a search query into search bar 321 to find a specific functional component. In response to the user input, partition 320 may limit the listing of available functional component(s) to those which match the search query. It should be appreciated that other systems and methods for searching for available functional component(s) can be included.

Third partition 330 may provide information regarding the overall functional component that is being managed in the form of a visual preview. As illustrated in the example embodiment in FIG. 3, a functional component of a button with the text “login”, and an icon of a door is previewed to the user in partition 330. In some embodiments, the user may additionally be able to interact with the preview in partition 330 by entering a user input (for example by clicking on parts of the preview, dragging across the preview with a mouse to resize some elements, etc.) in order to, for example, select a particular sub-component, or modify some design properties of one or more sub-components via the visual preview. Third partition 330 may be updated as design property(s) of sub-components of the functional component are modified (in real-time, or after the update is applied, etc.) in order to provide visual feedback to the user regarding modifications made to the functional component.

According to an embodiment, third partition 330 may also provide information regarding the status of the user's current operation. As illustrated in the example embodiment in FIG. 3, third partition 330 indicates that the user is editing a custom component. It should be appreciated that such a status indicator can be placed anywhere within GUI 300, and is not limited to being placed in partition 330.

Fourth partition 340 may provide a listing of the design properties associated with the sub-component to be managed (added, modified, etc.). As illustrated in the example embodiment in FIG. 3, fourth partition 340 may be in the form of a property editor. Block element 341 indicates the name of the sub-component. It is contemplated that the user may interact with block element 341 in order to change the name of the sub-component by entering a user input (for example, by double clicking block element 341 with a mouse). Block element 342 may allow the user to toggle between viewing the properties as a list of input fields, or viewing the code directly. Referring back to the example embodiment in FIG. 3, the user may select between “property edit” and “code edit” in order to toggle between viewing the properties as a list of input fields, or viewing the code directly, respectively. In the illustrated embodiment in FIG. 3, the user has currently selected “property edit”. Accordingly, input fields 343, 344, 345, 346, 347 are displayed. Each input field may be associated with one or more respective properties of the associated sub-component. It should be appreciated that any number of input fields can be implemented, as appropriate for the respective sub-component

The user may interact with any of input fields 343, 344, 345, 346, and 347 to modify a particular property of the selected sub-component. In an embodiment, the user may type the name of the property into an input field. In the illustrated embodiment in FIG. 3, input fields 343, 344, 345, 346, and 347 may display a drop-down menu (an example embodiment illustrated in FIG. 5, discussed in detail below) when pressing the triangle button in the respective input field. Such interaction may allow the user to select between various properties of the associated sub-component which may be linked to the input field. In some embodiments, further user interaction with input fields 343, 344, 345, 346, and 347 may also allow the user to generate a sub-window to overlay with GUI 300 (an example embodiment illustrated in FIG. 4, discussed in detail below).

FIG. 4 illustrates an example GUI 400 for adding a new customized design property associated with the sub-component, according to one or more embodiments. The GUI 400 may be generated and presented to the user, upon detecting a user interaction with any of input fields 343, 344, 345, 346, 347 of GUI 300 in FIG. 3, although it should be appreciated that GUI 400 can be presented to the user upon interaction with any other appropriate user interaction with example GUI 300. In an embodiment, GUI 400 may be presented in a form of a sub-window overlaying GUI 300, for instance, as illustrated in the example embodiment in FIG. 4, GUI 400 may include a plurality of input fields 401, 402, and 403, along with interactive elements 404 and 405. It should be appreciated that any number of input fields can be implemented, as appropriate for the respective sub-component.

In an embodiment, the user may interact with input field 401 to name the customized design property. In the example embodiment illustrated in FIG. 4, the user has entered an input to input field 401 to name the design property “button label”. According to an embodiment, the parameter in input field 401 (i.e., the name of the customized design property) may be prepopulated by the App builder (or one or more modules included therein). For example, if the user triggered GUI 400 for adding the new customized design property by copying an existing design property, the App builder (or one or more modules included therein) may determine the name/title of the existing design property and prepopulate the parameter of the input field 401 according to the name of the existing design property. Alternatively, the App builder (or one or more modules included therein) may determine (e.g., from a user profile, etc.) a project or an application the user is working on, and may prepopulate the parameter of the input field 401 according to the ID or title of the project or application.

The user may also enter the appropriate values for the design property in input fields 402 and 403. In the example embodiment illustrated in FIG. 4, the user may interact with input field 402 to select the type of design property as a “text” property type, and the user may interact with input field 403 to select the default value of the property to be “button”. Input field 402, for instance may be a drop-down list when interacted with, since the available types of properties associated with the sub-component may have a relatively smaller number of possible options. It should be appreciated that the input fields 402 and 403 may not necessarily be limited to text input, and other forms of input (for example, a slider, a checkbox. etc.) could be implemented.

Once the user is finished configuring the design property of the sub-component, the user may interact with interactive element 405 (illustrated as a “Save” button in FIG. 4), and the App builder (or one or more modules included therein) may retrieve and collect the user input from input fields 401, 402, and 403 and either generate a new customized charter or modify an existing customized charter. Subsequently, the App builder (or one or more modules included therein) may update one or more configuration profiles associated with the user to include the customized charter ID thereto, and may update one or more GUIs presented to the user (e.g., GUI 300) to include the information of the newly added customized design property of the sub-component (for example, partitions 330 and 340 may be updated in a manner similar to as previously discussed). Further descriptions associated with the updated GUI are provided below with reference to FIG. 5.

On the other hand, the user may interact with interactive element 406 to stop or discard the addition of new customized design option. According to an embodiment, upon determining a user interaction with the interactive element 406 (e.g., user pressing the “cancel” button, etc.), the App builder (or one or more modules included therein) may query the user for saving the current configuration for use by a future user (e.g., save the partially configured design option in a record file and store the record file in storage module 120, without actually updating the design charter, etc.). Alternatively, the App builder (or one or more modules included therein) may simply close GUI 400 and redirect the user back to the previous GUI (e.g., GUI 300 in FIG. 3, etc.).

It can be understood that, although FIG. 4 and the associated features are described in relation to function or process for adding a new customized design property of a sub-component, and, similar GUI(s) and processes may be presented to the user to adjust or modify the configuration of design property(s) of sub-components associated with the functional component, without departing from the scope of the present disclosure.

FIG. 5 illustrates an example of updated GUI 500 for the design properties of the sub-components of the functional component. GUI 500 may be presented by the App builder (or one or more modules included therein) upon determining a user interaction on the interactive element 405 in FIG. 4. Further, GUI 500 may be an updated version of GUI 300 in FIG. 3 and may include one or more features, information, and interactive elements of GUI 300, and thus the redundant descriptions associated therewith may be omitted below for conciseness.

Referring to FIG. 5, the third partition 530 of GUI 500 includes an updated preview of the functional component after the new design property for the text sub-component of the functional component from GUI 400 illustrated in FIG. 4 is added. In particular, it can be understood that the text of the button has been modified from “login” in third partition 330 of GUI 300 prior to the update, to “button” in third partition 530 of GUI 500 after the update. This is consistent with the default value “button” inputted into input field 402 as illustrated in example embodiment in FIG. 4. In relation, fourth partition 540 of GUI 500 may include an updated view of the exemplified property editor, in which input field 543 has been updated from “Login” prior to the update, to “button label” after the update. This is consistent with the name “button label” inputted into input field 401 as illustrated in FIG. 4.

Referring still to FIG. 5, input field 545 of GUI 500 may be selected by the user, in order to display interactive elements 545_1, 545_2, and 545_3. Interactive elements 545_1, 545_2, and 545_3 may be in the form a list (such as a sub-menu), in order to allow for the user to select between adding a new design property for the sub-component, or to select existing customized or pre-defined design properties for the sub-component. As illustrated in FIG. 5, the user may select interactive element 545_1 (which indicates that a new property could be created with the “+” icon”), in order to generate a GUI such as or similar to GUI 400 as discussed above, so that the user may create a new design property. The new design property may be associated with the property type related to input field 545. in the illustrated embodiment in FIG. 5, this may result in a new design property associated with the “color” type, although it should be appreciated that this process may be applied with any type of design property associated with the one or more sub-components of the functional component.

Alternatively, the user may select interactive elements 545_2 or 545_3 to select existing customized or pre-defined design property(s). As illustrated in FIG. 5, this may allow the user to select interactive element 545_2 to select “Icon Label and Color” or “Button Color”. If an existing design property associated with the sub-component is selected, GUI 500 may be further updated to reflect the changes in a similar process as discussed above relative to GUI 300.

Next, FIG. 6 illustrates an example GUI 600 presented to a user for listing the available functional components that may be used by the user in the App builder. This may include the example “button” functional component which was being modified/managed in example GUIs 300, 400, and 500 as illustrated in FIG. 3-5 as discussed above. It should be noted that GUI 600 may be an updated/similar version of second partition 320 in GUI 300 in FIG. 3 or second partition 520 in GUI 500, and thus the redundant descriptions associated therewith are omitted below for conciseness.

GUI 600 may be displayed either together, or independently of example GUIs 300, 400, and 500. For instance, the list of available functional components may be displayed independently of the property editor GUI illustrated in example GUIs 300, 400, and 500. This may allow only certain users (for example, a user which is registered as an administrator) to access the property editor portion of the App builder.

It is contemplated that the above described GUI 300 to GUI 600, as well as the descriptions associated therewith, are merely example embodiments provided herein for descriptive purpose, and should not in any means restrict the scope of the present disclosure. Specifically, one or more of said GUI 300 to GUI 600 may be arranged in a different manner, may include more or less features and/or information as compared to those as described, and the operations associated therewith may be performed in a different manner, without departing from the scope of the present disclosure.

Ultimately, example embodiments of present disclosure provide comprehensive information associated with the one or more design properties of the sub-components of the functional components, and allow a user to easily customize and manage each functional component on the sub-component level.

### Customized Design Charter and Configuration Profile

As discussed above with reference to FIG. 2, the App builder (or one or more modules included therein) may generate a customized design charter (may be referred to as “customized charter” hereinafter) based on one or more user inputs for managing the customized functional component(s). According to an embodiment, the customized charter may include a customized charter ID and configurations for customized functional component(s). In addition, the customized charter may also include the customized design properties for the related sub-component(s) of the functional component with reference to each customized charter ID. The customized charter ID may be automatically generated by the App builder (e.g., module 112) based on an user input (e.g., a text inputted by the user in the text field defining the name of the customized functional component, etc.).

The customized charter ID may be a hypertext (or any other suitable format) which may interconnect the customized charter with the customized functional component and the associated configuration profile. In this way, whenever the user changes the configuration of the customized functional component (e.g., changes a design property of one of the sub-component(s)), said changes will be automatically reflected with reference to the customized charter ID as well as in the configuration profile.

FIG. 7 illustrates examples of customized design charters, according to one or more embodiments. In this regard, table 710 illustrates a customized charter associated with a functional component that is a button having a customized shape parameter (which is linked to the viewable container sub-component) and icon alignment parameter (which is linked to the icon sub-component), and table 720 illustrates another customized charter associated with a customized slider having a customized dimension parameter (which is linked to the viewable container sub-component) and scrolling speed parameter (which is linked to the touchable container sub-component). It should be noted that the above are merely examples of possible design properties and related sub-components.

According to another embodiment, one customized charter may be generated for a user or for a group of users. For example, a plurality of customized functional components associated with a user or a group of users may be compiled in one customized charter, without departing from the scope of the present disclosure.

Further, as also discussed above with reference to FIG. 2, when generating the customized charter, the App builder (or one or more modules included therein) may update an associated configuration profile. The configuration profile may be created by the App builder and be assigned to the user whenever the user create a new project or share the configuration with other users (e.g., other team member, a friend, etc.).

FIG. 8 illustrates an example of configuration profile, according to one or more embodiments. Referring to FIG. 8, the configuration profile may include an associated configuration profile ID, a source charter ID, and one or more customized charter ID, although it can be understood that the configuration profile may include any other suitable information without departing from the scope of present disclosure. The configuration profile ID may be automatically generated by the App builder whenever the user create a new project or share the configuration with other users (e.g., other team member, a friend, etc.). The source charter ID may be automatically selected by the App builder based on the type of application or project, and/or may be manually added by the user. The customized charter ID may be automatically included or updated by the App builder (e.g., module 112) whenever an associated custom charter is created or is updated. The configuration profile may be stored in storage module 120 and may be retracted therefrom when required.

For instance, whenever a user has successfully login to the system, module 111 may receive the user information (e.g., user ID) from module 113, and may continuously or periodically obtain the configuration profile from the storage module 120 based on the user information. For example, module 111 may obtain the configuration profile from the storage module based on a mapping of user ID and configuration profile ID, as illustrated in FIG. 9. Accordingly, module 111 may continuously or periodically determine which design charter(s) is available to the user, may obtain the design charter(s) from storage module 120, and may generate an listing containing the most recent or updated available customized functional component based on the obtained design charter(s).

On the other hand, whenever a user has created or modified a customized functional component via one or more GUIs, the module 112 may receive the user information (e.g., user ID), along with one or more user inputs defining the customized functional component, from module 113. Accordingly, module 112 may generate or update a customized charter associated with the customized functional component. In this regard, based on determining that it is required to update the associated configuration profile (e.g., based on determining that a new customized charter is created, based on determining that a change in the customized charter ID is made, etc.), module 112 may obtain the associated configuration profile from storage 120 (e.g., when storing the customized charter to storage module 120, etc.) and may update the associated configuration profile accordingly (e.g., include the ID of the new customized charter, update ID of existing customized charter, etc.). In this way, any changes in the customized charter may be automatically and timely updated and reflected.

It is contemplated that the tables illustrated in FIG. 7 to FIG. 9 and the associated descriptions provided hereinabove are merely example embodiments for descriptive purpose, and one or more of the customized charter, the configuration profile, and the mapping may have a different arrangement without departing from the scope of the present disclosure. For instance, it can be understood that the information illustrated in said tables can also be in any suitable format (instead of table format), may include more or less information, and may be arranged in different manner, without departing from the scope of the present disclosure

### Sharing of a Customized Functional Component

According to an embodiment, a user may share his or her customized functional component to one or more users (e.g., a user working on the same project, a user under the same team, a friend, etc.). For instance, when creating or modifying a customized functional component, the user may choose whether or not said customized functional component shall be shared to another user(s).

FIG. 10 illustrates a block diagram of a method 1000 for managing sharing of a customized functional component, according to one or more embodiments. Method 1000 may be performed by App builder 110 (or one or more modules included therein).

Referring to FIG. 10, at operation 1000, the App builder may determine whether or not the sharing of the customized functional component is enabled.

According to an embodiment, the GUI for managing customized functional component (e.g., GUIs illustrated in FIG. 3 to FIG. 6, etc.) may include an interactive element (e.g., button, drop-down list, etc.) to allow the user to disable or enable the sharing of the customized functional component. Subsequently, the module 113 may receive the associated user input from the GUI and provide the same to module 112. Based on the received user input, the module 112 may determine whether or not the sharing of the customized functional component is enabled.

In some embodiments, based on determining that the user has not interacted with said interactive element (e.g., user has not specified whether or not the sharing of the customized functional component is enabled or is disabled), the App builder (e.g., module 113, module 112, etc.) may assume that the user would not like to share the customized functional component in default and may automatically determine that the sharing of the customized functional component is not enabled (i.e., is disabled). Conversely, in some embodiments, based on determining that the user has not interacted with said interactive element (e.g., user has not specified whether or not the sharing of the customized functional component is enabled or is disabled), the App builder (e.g., module 113, module 112, etc.) may assume that the user would like to share the customized functional component in default and may automatically determine that the sharing of the customized functional component is enabled.

Based on determining that the sharing of the customized functional component is enabled, the process proceeds to operation S1030, at which the customized functional component is shared to one or more associated users.

Specifically, whenever the user choose to enable the sharing of the customized functional component, the user may specify one or more users to which the customized functional component should be shared. According to an embodiment, the GUI (from which the user manage the customized functional component and enable the sharing of the customized functional component) may include an interactive element (e.g., text input field, drop-down list, etc.) to allow the user to specify to which user(s) the customized functional component should be shared. Accordingly, based on the user input(s), the module 112 may generate or update the associated customized charter and configuration profile.

By way of example, referring back to FIG. 7. In this example embodiments, the user has two customized charters (e.g., 710 and 720) associated therewith, and the user has disabled the sharing of customized functional component associated with customized charter 710 and has configured the sharing of customized functional component associated with customized charter 720 to user 0002 only. Thus, module 112 may configure or update customized charters 710 and 720 to include information or said configuration.

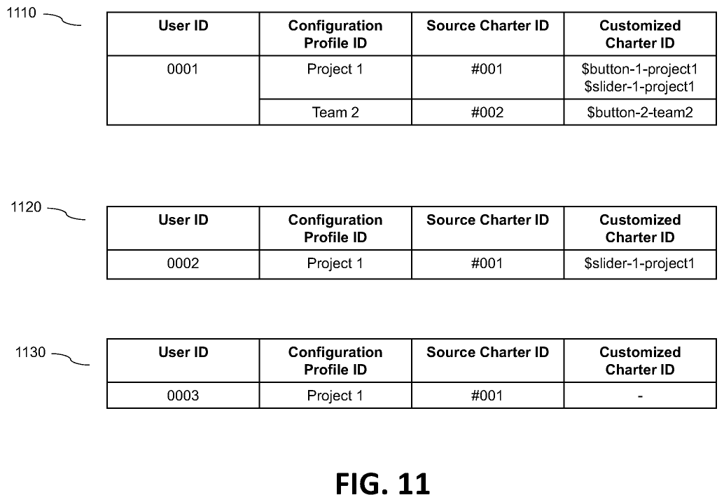

Further, the module 112 may generate or update configuration profile of the associated users accordingly. FIG. 11 illustrates an example of updated configuration profiles, according to one or more embodiments. The configuration profiles may be generated by the module 112 based on existing configuration profiles (e.g., configuration profile illustrated in FIG. 8, etc.) and mapping of user ID and configuration profile ID (e.g., mapping illustrated in FIG. 9, etc.).

Referring to FIG. 11, configuration profile 1110 may be associated with a user 0001 (i.e., the user who has created or managed the customized functional component). In this regard, the ID of both customized charters 710 and 720 (in FIG. 7) may be included in configuration profile 1110, such that the customized functional component associated with said customized charters will always be available to user 0001.

On the other hand, configuration profile 1120 may be associated with a user 0002, and configuration profile 1130 may be associated with a user 0003. In this regard, since user 0001 has disabled the sharing of customized functional component associated with customized charter 710 and has only enabled the sharing of customized functional component associated with customized charter 720 with user 0002, the module 112 may include only the ID of customized charter 720 in configuration profile 1120, while not including ID of any of customized charters 710 and 720 in configuration 1130. Accordingly, customized functional component associated with customized charter 710 may only be available to user 0001, and only customized functional component associated with customized charter 720 may be accessible to some other user(s).

According to an embodiment, a user who is not the creator or manager of the customized functional component may be allowed to share the customized functional component to another user. For instance, the creator or manager of the customized functional component may authorize another user to share the customized functional component to other user(s). Alternatively, the system may automatically enable a user to share a customized functional component to which the user has access.

It can be understood that the configuration profiles illustrated in FIG. 11 are merely example embodiments for descriptive purpose, and the configuration profiles may be arranged in a different manner to allow the sharing of customized functional component, without departing from the scope of present disclosure.

To this end, the example embodiments of the present disclosures allow a user to easily share one or more customized functional component to one or more associated users (e.g., users working on a same project, users from the same team, etc.), while effectively improve the information security since the customized functional component will not be accessible to non-associated users.

### Changing of a Customized Functional Component

According to an embodiment, a user may change or modify a customized functional component, and said change or modification may be automatically applied to one or more associated users and one or more associated applications which have utilized the customized deign option.

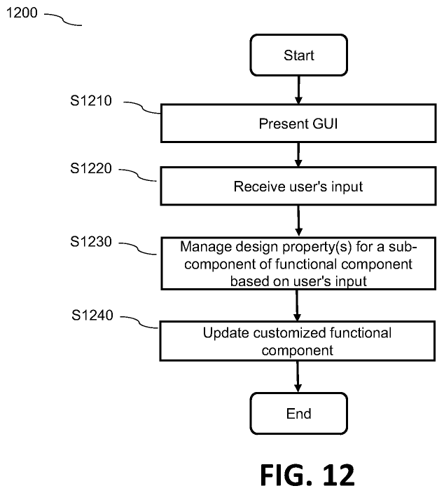

FIG. 12 illustrates a block diagram of a method 1200 for changing one or more design property(s) for one or more of the sub-component(s) of the functional component, according to one or more embodiments. It should be noted that the user may also opt to still add new design property(s) and or sub-component(s), without departing from the scope of the current disclosure. One or more operations of method 1200 may be similar to those described above with reference to method 200 of FIG. 2, thus redundant descriptions associated therewith may be omitted below for conciseness.

Referring to FIG. 12, at operation S1210, one or more GUIs are presented to a user. For instance, a GUI for managing one or more customized design property(s) for one or more of the sub-component(s) may be presented to the user. The GUI may be similar to the one illustrated in FIGS. 4 and 5 as described above, thus redundant descriptions associated therewith may be omitted below for conciseness.

At operation S1220, one or more user inputs are received. The process may be similar to operation S220 described above with reference to FIG. 2, thus redundant descriptions associated therewith may be omitted below for conciseness.

In this regard, based on determining that the user input is an interaction with an interactive element associated with the function for modifying a customized design property for one or more of the sub-component(s) (e.g., clicking on an edit button, etc.), the module 113 may generate and present another GUI (e.g., in the form of pop-out sub-window, etc.) to the user, so as to receive additional user inputs for changing or modifying the customized design property for one or more of the sub-component(s) therefrom. Said another GUI may be similar to the GUIs illustrated in FIG. 4 and FIG. 5, thus redundant descriptions associated therewith may be omitted below for conciseness.

At operation S1230, the App builder 110 (or one or more modules included therein) may update the GUI to present the updated one or more customized design property(s) for the related sub-components based on the user input.

For instance, the module 113 may provide the received user input(s) to module 112, module 112 may update the associated customized charter. Accordingly, module 111 may retrieve the updated customized charter for the customized functional component and generate a listing comprising the updated customized design properties for the related sub-components of the customized functional component, and may provide the listing to module 113 such that module 113 can generate an updated GUI including the updated customized design property(s) for the related sub-components of the customized functional component. This may allow the user to select the customized design property(s) to associate with the relevant sub-components of the customized functional component.

At operation S1240 the App builder 110 (or one or more modules included therein) may update the GUI to save the designed overall functional component, including all the updated configurations of the sub-component(s) in the existing customized functional component. For instance, the module 113 may provide the received user input(s) to module 112, module 112 may update the customized functional component to the customized charter/associated configuration in module 120. Accordingly, module 111 may retrieve the design charters (i.e., the source charter and the newly stored customized charter) from module 120, generate an updated listing of available customized functional components, and provide the updated listing to module 113. Subsequently, module 113 may generate an updated GUI including the updated customized functional components as well as any other pre-defined functional components, and present the same to the user (e.g., via user module 130).

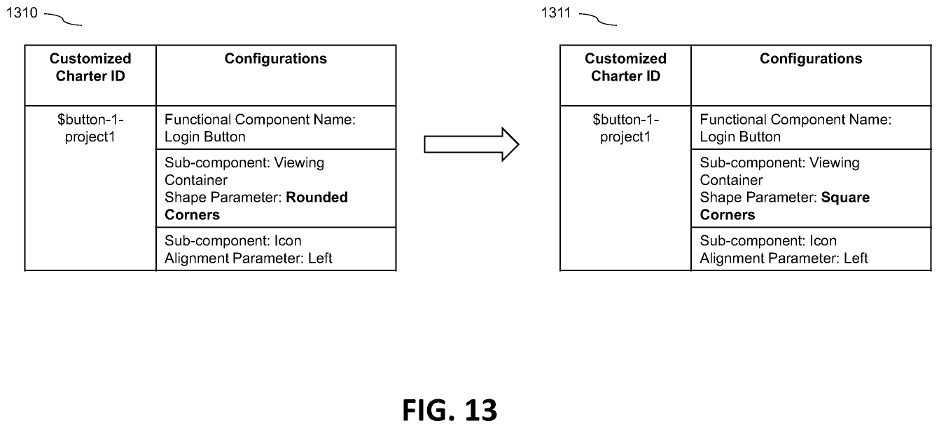

FIG. 13 illustrates an example use case of changing a customized functional component, according to one or more embodiment. In this example use case, the user has changed or modified the configurations of the customized functional component, without affecting the customized charter ID.

Referring to FIG. 13, customized charter 1310 is a customized charter for a customized button. In this example user case, the user has changed or modified the shape parameter associated with the viewing container to be from “rounded corners” to “square corners”. Since said changes do not affect the customized charter ID, the module 112 may simply update the customized charter 1310 accordingly. The updated customized charter is illustrated in customized charter 1311.

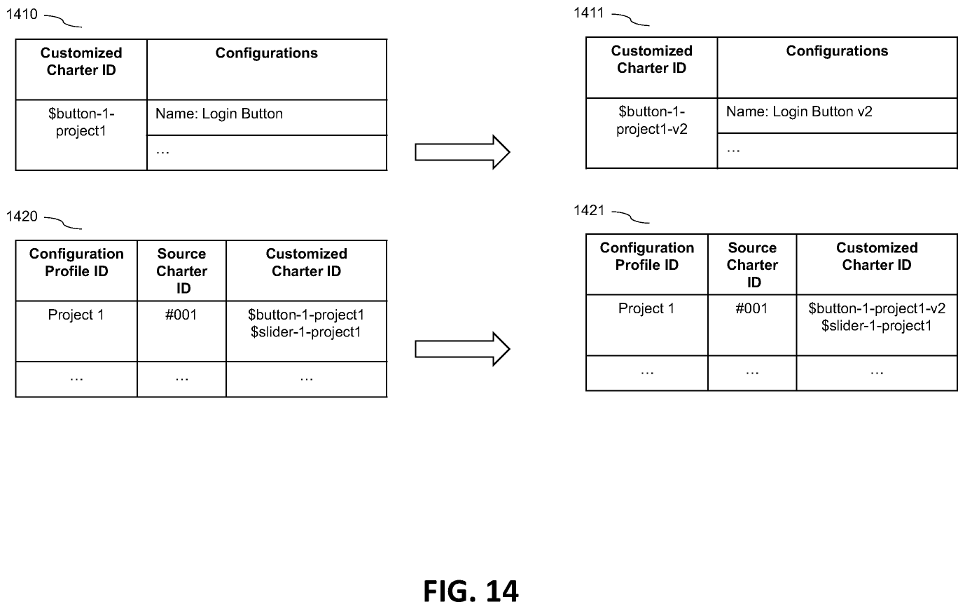

FIG. 14 illustrates another example use case of changing a customized functional component, according to one or more embodiments. In this example use case, the user has changed or modified the configurations of the same customized button as described in the example use case of FIG. 13, and the changes and modification may affect the customized charter ID.

Referring to FIG. 14, customized charter 1410 is a customized charter for a customized login button, which may be similar to customized charter 1310 in FIG. 13. In this example use case, the user has changed the name of the customized functional component from “Login Button” to “Login Button v2”.

According to an embodiment, the changes in the name of the customized functional component does not affect the customized charter ID, and the module 112 may simply update the customized charter without changing the customized charter ID, in a similar manner described above with reference to FIG. 13.

According to another embodiment, the name of the customized functional component may be generated in the form of hypertext and may be associated (or interconnected) with the customized charter ID. In that case, the customized charter ID will be concurrently updated (e.g., by the module 112) according to the updated name of the customized functional component. For instance, as illustrated in FIG. 14, customized charter ID of customized charter 1410 are updated from “$button-1-project1” to “$button-1-project1-v2” (as illustrated in updated customized charter 1411), according to the changes made on the name of the customized functional component.

Further, the customized charter ID included in the customized charter may also be generated in the form of hypertext and may be associated (or interconnected with) the customized charter ID included in the configuration profile(s) and/or the customized charter ID in the programming codes of the application which has utilized the customized design charter. In that case, the customized charter ID in the configuration profile(s) and/or the customized charter ID in the programming codes may be concurrently updated (e.g., by the module 112) according to the updated name of the customized functional component.

Referring to FIG. 14, configuration profile 1420 includes the customized charter ID similar to the customized charter ID of customized charter 1410 (before the name of the customized functional component is changed by the user). Subsequently, upon determining a change in the customized charter ID of the associated customized charter, the customized charter ID of the configuration profile may be updated according to the changes. For instance, in the example use case of FIG. 14, the customized charter ID of configuration profile 1420 is updated from “$button-1-project1” to “$button-1-project1-v2”, which is consistent with the updated customized charter ID in the updated customized charter 1411.

According to an embodiment, only authorized user(s) (i.e., user(s) authorized by the creator or manager of the customized functional component) may change or modify a customized functional component. According to another embodiment, all user(s) which has access to the customized functional component. may change or modify the customized functional component. In this regard, an unauthorized user(s) may change or modify the customized functional component, and the App builder may request authorization from the creator or manager of the customized functional component. before updating the associated customized charter, configuration profile, and/or programming codes. If the creator or manager of the customized functional component. agree with the changes and allow the changes to be updated in the associated customized charter, configuration profile, and/or programming codes, the App builder may update said information accordingly.

In view of the above, example embodiments of the present disclosure allow a user to easily update a customized functional component. Specifically, whenever the user has made a change or a modification on the customized functional component, said change or modification may be automatically applied to the associated information (e.g., customized charter, configuration profile, programming codes, etc.). Accordingly, the system may automatically perform the required update(s) based on the user's change or modification, which in turns reduce the user's burden in updating the stylistic design, improve the efficiency and effectiveness in managing the changes or modification in the customized functional components, and reduce the risk of introducing errors.

### Implementation Environment and Device

FIG. 15 is a diagram of an example environment 1500 in which systems and/or methods, described herein, may be implemented. As shown in FIG. 15, environment 1500 may include a user device 1510, a platform 1520, and a network 1530. Devices of environment 1500 may interconnect via wired connections, wireless connections, or a combination of wired and wireless connections. In embodiments, any of the functions and operations described with reference to FIG. 1 to FIG. 14 above may be performed by any combination of elements illustrated in FIG. 15.

User device 1510 includes one or more devices capable of receiving, generating, storing, processing, and/or providing information associated with platform 1520. For example, user device 1510 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 1510 may receive information from and/or transmit information to platform 1520.

Platform 1520 includes one or more devices capable of receiving, generating, storing, processing, and/or providing information. In some implementations, platform 1520 may include a cloud server or a group of cloud servers. In some implementations, platform 1520 may be designed to be modular such that certain software components may be swapped in or out depending on a particular need. As such, platform 1520 may be easily and/or quickly reconfigured for different uses.

In some implementations, as shown, platform 1520 may be hosted in cloud computing environment 1522. Notably, while implementations described herein describe platform 1520 as being hosted in cloud computing environment 1522, in some implementations, platform 1520 may not be cloud-based (i.e., may be implemented outside of a cloud computing environment) or may be partially cloud-based.

Cloud computing environment 1522 includes an environment that hosts platform 1520. Cloud computing environment 1522 may provide computation, software, data access, storage, etc. services that do not require end-user (e.g., user device 1510) knowledge of a physical location and configuration of system(s) and/or device(s) that hosts platform 1520. As shown, cloud computing environment 1522 may include a group of computing resources 1524 (referred to collectively as “computing resources 1524” and individually as “computing resource 1524”).

Computing resource 1524 includes one or more personal computers, a cluster of computing devices, workstation computers, server devices, or other types of computation and/or communication devices. In some implementations, computing resource 1524 may host platform 1520. The cloud resources may include compute instances executing in computing resource 1524, storage devices provided in computing resource 1524, data transfer devices provided by computing resource 1524, etc. In some implementations, computing resource 1524 may communicate with other computing resources 1524 via wired connections, wireless connections, or a combination of wired and wireless connections.

As further shown in FIG. 15, computing resource 1524 includes a group of cloud resources, such as one or more applications (“APPs”) 1524-1, one or more virtual machines (“VMs”) 1524-2, virtualized storage (“VSs”) 1524-3, one or more hypervisors (“HYPs”) 1524-4, or the like.

Application 1524-1 includes one or more software applications that may be provided to or accessed by user device 1510. Application 1524-1 may eliminate a need to install and execute the software applications on user device 1510. For example, application 1524-1 may include software associated with platform 1520 and/or any other software capable of being provided via cloud computing environment 1522. In some implementations, one application 1524-1 may send/receive information to/from one or more other applications 1524-1, via virtual machine 1524-2.

Virtual machine 1524-2 includes a software implementation of a machine (e.g., a computer) that executes programs like a physical machine. Virtual machine 1524-2 may be either a system virtual machine or a process virtual machine, depending upon use and degree of correspondence to any real machine by virtual machine 1524-2. A system virtual machine may provide a complete system platform that supports execution of a complete operating system (“OS”). A process virtual machine may execute a single program, and may support a single process. In some implementations, virtual machine 1524-2 may execute on behalf of a user (e.g., user device 1510), and may manage infrastructure of cloud computing environment 1522, such as data management, synchronization, or long-duration data transfers.

Virtualized storage 1524-3 includes one or more storage systems and/or one or more devices that use virtualization techniques within the storage systems or devices of computing resource 1524. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1524-4 may provide hardware virtualization techniques that allow multiple operating systems (e.g., “guest operating systems”) to execute concurrently on a host computer, such as computing resource 1524. Hypervisor 1524-4 may present a virtual operating platform to the guest operating systems, and may manage the execution of the guest operating systems. Multiple instances of a variety of operating systems may share virtualized hardware resources.

Network 1530 includes one or more wired and/or wireless networks. For example, network 1530 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 15 are provided as an example. In practice, there may be additional devices and/or networks, fewer devices and/or networks, different devices and/or networks, or differently arranged devices and/or networks than those shown in FIG. 15. Furthermore, two or more devices shown in FIG. 15 may be implemented within a single device, or a single device shown in FIG. 15 may be implemented as multiple, distributed devices. Additionally, or alternatively, a set of devices (e.g., one or more devices) of environment 1500 may perform one or more functions described as being performed by another set of devices of environment 1500.

FIG. 16 is a diagram of example components of a device 1600. As shown in FIG. 16, device 1600 may include a bus 1610, a processor 1620, a memory 1630, a storage component 1640, an input component 1650, an output component 1660, and a communication interface 1670. In embodiments, any of the functions and operations described with reference to FIG. 1 to FIG. 14 above may be performed by any combination of elements illustrated in FIG. 16.

Bus 1610 includes a component that permits communication among the components of device 1600. Processor 1620 may be implemented in hardware, firmware, or a combination of hardware and software. Processor 1620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 2160 includes one or more processors capable of being programmed to perform a function. Memory 1630 includes a random access memory (RAM), a read only memory (ROM), and/or another type of dynamic or static storage device (e.g., a flash memory, a magnetic memory, and/or an optical memory) that stores information and/or instructions for use by processor 1620.

Storage component 1640 stores information and/or software related to the operation and use of device 1600. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 1650 includes a component that permits device 1600 to receive information, such as via user input (e.g., a touch screen display, a keyboard, a keypad, a mouse, a button, a switch, and/or a microphone). Additionally, or alternatively, input component 1650 may include a sensor for sensing information (e.g., a global positioning system (GPS) component, an accelerometer, a gyroscope, and/or an actuator). Output component 1660 includes a component that provides output information from device 1600 (e.g., a display, a speaker, and/or one or more light-emitting diodes (LEDs)).

Communication interface 1670 includes a transceiver-like component (e.g., a transceiver and/or a separate receiver and transmitter) that enables device 1600 to communicate with other devices, such as via a wired connection, a wireless connection, or a combination of wired and wireless connections. Communication interface 1670 may permit device 1600 to receive information from another device and/or provide information to another device. For example, communication interface 1670 may include an Ethernet interface, an optical interface, a coaxial interface, an infrared interface, a radio frequency (RF) interface, a universal serial bus (USB) interface, a Wi-Fi interface, a cellular network interface, or the like.

Device 1600 may perform one or more processes described herein. Device 1600 may perform these processes in response to processor 1620 executing software instructions stored by a non-transitory computer-readable medium, such as memory 1630 and/or storage component 1640. A computer-readable medium is defined herein as a non-transitory memory device. A memory device includes memory space within a single physical storage device or memory space spread across multiple physical storage devices.

Software instructions may be read into memory 1630 and/or storage component 1640 from another computer-readable medium or from another device via communication interface 1670. When executed, software instructions stored in memory 1630 and/or storage component 1640 may cause processor 1620 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 16 are provided as an example. In practice, device 1600 may include additional components, fewer components, different components, or differently arranged components than those shown in FIG. 16. Additionally, or alternatively, a set of components (e.g., one or more components) of device 1600 may perform one or more functions described as being performed by another set of components of device 1600.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

### Various Aspects of Embodiments

Various further respective aspects and features of embodiments of the present disclosure may be defined by the following items:

Item [1]: An apparatus comprising: at least one memory storage storing computer-executable instructions; and at least one processor communicatively coupled to the memory storage, wherein the at least one processor is configured to execute the computer-executable instructions to: present, to a user, a first graphical user interface (GUI) comprising information of a functional component, wherein the functional component is comprised of one or more sub-components; receive, from the user via the first GUI, a user input for managing a property associated with the one or more sub-components; manage the property associated with the one or more sub-components based on the user input; and updating the functional component based on the property.

Item [2]: The apparatus according to item [1], wherein the at least one processor is configured to execute the computer-executable instructions to present the first GUI by: obtaining at least one source design charter associated with the functional component; generating, based on the at least one design charter, a listing of properties including at least one property associated with the one or more sub-components predefined by the source design charter; generate, based on the listing of properties, the first GUI; and provide the first GUI to a user terminal associated with the user.

Item [3]: The apparatus according to any one of items [1]-[2], wherein the first GUI comprises a plurality of interactive elements, each of which is associated with an operation for managing the functional component, wherein the user input comprises a user interaction with at least one interactive element of the plurality of interactive elements, and wherein the at least one processor is configured to execute the computer-executable instructions to manage the functional component by: determining, based on the user input, the operation associated with the interactive element with which the user has interacted; and performing the operation to manage the functional component.

Item [4]: The apparatus according to item [3], wherein the at least one processor is further configured to execute the computer-executable instructions to manage the functional component by: based on determining that the operation is a creation of a new customized property associated with the one or more sub-components, present, to the user, a second GUI comprising one or more interactive elements for specifying the configuration of the new customized property associated with the one or more sub-components; receive, from the user via the second GUI, a user interaction with the one or more interactive elements; generate, based on the user interaction, a new customized design charter, wherein the new customized design charter defines the user-specified configuration of the new customized property associated with the one or more sub-components; update, based on the new customized design charter, the first GUI to include information associated with the new customized property associated with the one or more sub-components; and update, based on the new customized design charter, the first GUI to include information associated with the functional component as a result of the new customized property associated with the one or more sub-components.

Item [5]: The apparatus according to item [3], wherein the at least one processor is further configured to execute the computer-executable instructions to manage the functional component by: on determining that the operation is a modification of an existing customized property associated with the one or more sub-components, present, to the user, a second GUI comprising information associated with the existing customized property associated with the one or more sub-components and one or more interactive elements for modifying the existing customized property associated with the one or more sub-components; receive, from the user via the second GUI, a user interaction with the one or more interactive elements; update, based on the user interaction, a customized design charter associated with the existing customized property associated with the one or more sub-components, wherein the updated customized design charter defines a modified customized property associated with the one or more sub-components; and update, based on the updated customized design charter, the first GUI to include information associated with the modified customized property associated with the one or more sub-components; and update, based on the updated customized design charter, the first GUI to include information associated with the functional component as a result of the modified customized property.

Item [6]: The apparatus according to item [3], wherein the at least one processor is further configured to execute the computer-executable instructions to manage the functional component by: based on determining that the operation is a sharing of the functional component, present, to the user, a second GUI comprising information associated with the functional component and one or more interactive elements for specifying at least one user to which the functional component should be shared; receive, from the user via the second GUI, a user interaction with the one or more interactive elements; obtain, based on the user interaction, at least one configuration profile associated with the at least one user; and update the at least one configuration profile to include an ID of a customized design charter associated with the functional component.

Item [7]: The apparatus according to any one of items [1]-[6], wherein the functional component comprises one of a button, a slider, a column, a container, a text, a card, or a cell.

Item [8]: The apparatus according to any one of items [1]-[6], wherein the one or more sub-components comprises at least one or more of a text, a touchable container, a viewable container, an image, a button, a picker, a text field, and an icon.

Item [9]: A method performed by at least one processor, comprising: presenting, to a user, a first graphical user interface (GUI) comprising information of a functional component, wherein the functional component is comprised of one or more sub-components; receiving, from the user via the first GUI, a user input for managing a property associated with the one or more sub-components; managing the property associated with the one or more sub-components based on the user input; and updating the functional component based on the property.

Item [10]: The method according to item [9], wherein the presenting the first GUI comprises: obtaining at least one source design charter associated with the functional component; generating, based on the at least one design charter, a listing of properties including at least one property associated with the one or more sub-components predefined by the source design charter; generate, based on the listing of properties, the first GUI; and provide the first GUI to a user terminal associated with the user.

Item [11]: The method according to any one of items [9]-[10], wherein the first GUI comprises a plurality of interactive elements, each of which is associated with an operation for managing the functional component, wherein the user input comprises a user interaction with at least one interactive element of the plurality of interactive elements, and wherein managing the functional component comprises: determining, based on the user input, the operation associated with the interactive element with which the user has interacted; and performing the operation to manage the functional component.

Item [12] The method according to item [11], wherein managing the functional component comprises: based on determining that the operation is a creation of a new customized property associated with the one or more sub-components, present, to the user, a second GUI comprising one or more interactive elements for specifying the configuration of the new customized property associated with the one or more sub-components; receive, from the user via the second GUI, a user interaction with the one or more interactive elements; generate, based on the user interaction, a new customized design charter, wherein the new customized design charter defines the user-specified configuration of the new customized property associated with the one or more sub-components; update, based on the new customized design charter, the first GUI to include information associated with the new customized property associated with the one or more sub-components; and update, based on the new customized design charter, the first GUI to include information associated with the functional component as a result of the new customized property associated with the one or more sub-components.

Item [13] The method according to item [11], wherein managing the functional component further comprises: based on determining that the operation is a modification of an existing customized property associated with the one or more sub-components, presenting, to the user, a second GUI comprising information associated with the existing customized property associated with the one or more sub-components and one or more interactive elements for modifying the existing customized property associated with the one or more sub-components; receiving, from the user via the second GUI, a user interaction with the one or more interactive elements; updating, based on the user interaction, a customized design charter associated with the existing customized property associated with the one or more sub-components, wherein the updated customized design charter defines a modified customized property associated with the one or more sub-components; and updating, based on the updated customized design charter, the first GUI to include information associated with the modified customized property associated with the one or more sub-components; and updating, based on the updated customized design charter, the first GUI to include information associated with the functional component as a result of the modified customized property.

Item [14] The method according to item [11], wherein managing the functional component further comprises: based on determining that the operation is a sharing of the functional component, presenting, to the user, a second GUI comprising information associated with the functional component and one or more interactive elements for specifying at least one user to which the functional component should be shared; receiving, from the user via the second GUI, a user interaction with the one or more interactive elements; obtaining, based on the user interaction, at least one configuration profile associated with the at least one user; and updating the at least one configuration profile to include an ID of a customized design charter associated with the functional component.

Item [15] The method according to any one of items [9]-[14], wherein the functional component comprises one of a button, a slider, a column, a container, a text, a card, or a cell.

Item [16] The method according to any one of items [9]-[14], wherein the one or more sub-components comprises at least one or more of text, a touchable container, a viewable container, an image, a button, a picker, a text field, and an icon.

Item [17] A non-transitory computer-readable recording medium having recorded thereon instructions executable by at least one processor to cause the at least one processor to perform a method comprising: presenting, to a user, a first graphical user interface (GUI) comprising information of a functional component, wherein the functional component is comprised of one or more sub-components; receiving, from the user via the first GUI, a user input for managing a property associated with the one or more sub-components; managing the property associated with the one or more sub-components based on the user input; and updating the functional component based on the property.

Item [18] The non-transitory computer-readable recording medium according to item [17], wherein the presenting the first GUI comprises: obtaining at least one source design charter associated with the functional component; generating, based on the at least one design charter, a listing of properties including at least one property associated with the one or more sub-components predefined by the source design charter; generate, based on the listing of properties, the first GUI; and provide the first GUI to a user terminal associated with the user. Item [19] The non-transitory computer-readable recording medium according to any one of items [17]-[18], wherein the first GUI comprises a plurality of interactive elements, each of which is associated with an operation for managing the functional component, wherein the user input comprises a user interaction with at least one interactive element of the plurality of interactive elements, and wherein managing the functional component comprises: determining, based on the user input, the operation associated with the interactive element with which the user has interacted; and performing the operation to manage the functional component.

Item [20] The non-transitory computer-readable recording medium according to item [19], wherein managing the functional component comprises: based on determining that the operation is a creation of a new customized property associated with the one or more sub-components, present, to the user, a second GUI comprising one or more interactive elements for specifying the configuration of the new customized property associated with the one or more sub-components; receive, from the user via the second GUI, a user interaction with the one or more interactive elements; generate, based on the user interaction, a new customized design charter, wherein the new customized design charter defines the user-specified configuration of the new customized property associated with the one or more sub-components; update, based on the new customized design charter, the first GUI to include information associated with the new customized property associated with the one or more sub-components; and update, based on the new customized design charter, the first GUI to include information associated with the functional component as a result of the new customized property associated with the one or more sub-components.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus comprising:
at least one memory storage storing computer-executable instructions; and
at least one processor communicatively coupled to the memory storage, wherein the at least one processor is configured to execute the computer-executable instructions to:
present, to a user, a first graphical user interface (GUI) comprising information of a functional component, wherein the functional component is comprised of one or more sub-components;
receive, from the user via the first GUI, a user input for managing a property associated with the one or more sub-components;
manage the property associated with the one or more sub-components based on the user input; and
updating the functional component based on the property.

2. The apparatus as claimed in claim 1, wherein the at least one processor is configured to execute the computer-executable instructions to present the first GUI by:
obtaining at least one source design charter associated with the functional component;
generating, based on the at least one design charter, a listing of properties including at least one property associated with the one or more sub-components predefined by the source design charter;
generate, based on the listing of properties, the first GUI; and
provide the first GUI to a user terminal associated with the user.

3. The apparatus as claimed in claim 1, wherein the first GUI comprises a plurality of interactive elements, each of which is associated with an operation for managing the functional component, wherein the user input comprises a user interaction with at least one interactive element of the plurality of interactive elements, and wherein the at least one processor is configured to execute the computer-executable instructions to manage the functional component by:
determining, based on the user input, the operation associated with the interactive element with which the user has interacted; and
performing the operation to manage the functional component.

4. The apparatus as claimed in claim 3, wherein the at least one processor is further configured to execute the computer-executable instructions to manage the functional component by:
based on determining that the operation is a creation of a new customized property associated with the one or more sub-components, present, to the user, a second GUI comprising one or more interactive elements for specifying the configuration of the new customized property associated with the one or more sub-components;
receive, from the user via the second GUI, a user interaction with the one or more interactive elements;
generate, based on the user interaction, a new customized design charter, wherein the new customized design charter defines the user-specified configuration of the new customized property associated with the one or more sub-components;
update, based on the new customized design charter, the first GUI to include information associated with the new customized property associated with the one or more sub-components; and
update, based on the new customized design charter, the first GUI to include information associated with the functional component as a result of the new customized property associated with the one or more sub-components.

5. The apparatus as claimed in claim 3, wherein the at least one processor is further configured to execute the computer-executable instructions to manage the functional component by:
based on determining that the operation is a modification of an existing customized property associated with the one or more sub-components, present, to the user, a second GUI comprising information associated with the existing customized property associated with the one or more sub-components and one or more interactive elements for modifying the existing customized property associated with the one or more sub-components;
receive, from the user via the second GUI, a user interaction with the one or more interactive elements;
update, based on the user interaction, a customized design charter associated with the existing customized property associated with the one or more sub-components, wherein the updated customized design charter defines a modified customized property associated with the one or more sub-components; and
update, based on the updated customized design charter, the first GUI to include information associated with the modified customized property associated with the one or more sub-components; and
update, based on the updated customized design charter, the first GUI to include information associated with the functional component as a result of the modified customized property.

6. The apparatus as claimed in claim 3, wherein the at least one processor is further configured to execute the computer-executable instructions to manage the functional component by:
based on determining that the operation is a sharing of the functional component, present, to the user, a second GUI comprising information associated with the functional component and one or more interactive elements for specifying at least one user to which the functional component should be shared;
receive, from the user via the second GUI, a user interaction with the one or more interactive elements;
obtain, based on the user interaction, at least one configuration profile associated with the at least one user; and
update the at least one configuration profile to include an ID of a customized design charter associated with the functional component.

7. The apparatus as claimed in claim 1, wherein the functional component comprises one of a button, a slider, a column, a container, a text, a card, or a cell.

8. The apparatus as claimed in claim 1, wherein the one or more sub-components comprises at least one or more of text, a touchable container, a viewable container, an image, a button, a picker, a text field, and an icon.

9. A method performed by at least one processor, comprising:
presenting, to a user, a first graphical user interface (GUI) comprising information of a functional component, wherein the functional component is comprised of one or more sub-components;
receiving, from the user via the first GUI, a user input for managing a property associated with the one or more sub-components;
managing the property associated with the one or more sub-components based on the user input; and
updating the functional component based on the property.

10. The method as claimed in claim 9, wherein the presenting the first GUI comprises:
obtaining at least one source design charter associated with the functional component;
generating, based on the at least one design charter, a listing of properties including at least one property associated with the one or more sub-components predefined by the source design charter;
generate, based on the listing of properties, the first GUI; and
provide the first GUI to a user terminal associated with the user.

11. The method as claimed in claim 9, wherein the first GUI comprises a plurality of interactive elements, each of which is associated with an operation for managing the functional component, wherein the user input comprises a user interaction with at least one interactive element of the plurality of interactive elements, and wherein managing the functional component comprises:
determining, based on the user input, the operation associated with the interactive element with which the user has interacted; and
performing the operation to manage the functional component.

12. The method as claimed in claim 11, wherein managing the functional component comprises:
based on determining that the operation is a creation of a new customized property associated with the one or more sub-components, present, to the user, a second GUI comprising one or more interactive elements for specifying the configuration of the new customized property associated with the one or more sub-components;
receive, from the user via the second GUI, a user interaction with the one or more interactive elements;
generate, based on the user interaction, a new customized design charter, wherein the new customized design charter defines the user-specified configuration of the new customized property associated with the one or more sub-components;
update, based on the new customized design charter, the first GUI to include information associated with the new customized property associated with the one or more sub-components; and
update, based on the new customized design charter, the first GUI to include information associated with the functional component as a result of the new customized property associated with the one or more sub-components.

13. The method as claimed in claim 11, wherein managing the functional component further comprises:
based on determining that the operation is a modification of an existing customized property associated with the one or more sub-components, presenting, to the user, a second GUI comprising information associated with the existing customized property associated with the one or more sub-components and one or more interactive elements for modifying the existing customized property associated with the one or more sub-components;
receiving, from the user via the second GUI, a user interaction with the one or more interactive elements;
updating, based on the user interaction, a customized design charter associated with the existing customized property associated with the one or more sub-components, wherein the updated customized design charter defines a modified customized property associated with the one or more sub-components; and
updating, based on the updated customized design charter, the first GUI to include information associated with the modified customized property associated with the one or more sub-components; and
updating, based on the updated customized design charter, the first GUI to include information associated with the functional component as a result of the modified customized property.

14. The method as claimed in claim 11, wherein managing the functional component further comprises:
based on determining that the operation is a sharing of the functional component, presenting, to the user, a second GUI comprising information associated with the functional component and one or more interactive elements for specifying at least one user to which the functional component should be shared;
receiving, from the user via the second GUI, a user interaction with the one or more interactive elements;
obtaining, based on the user interaction, at least one configuration profile associated with the at least one user; and
updating the at least one configuration profile to include an ID of a customized design charter associated with the functional component.

15. The method as claimed in claim 9, wherein the functional component comprises one of a button, a slider, a column, a container, a text, a card, or a cell.

16. The method as claimed in claim 9, wherein the one or more sub-components comprises at least one or more of text, a touchable container, a viewable container, an image, a button, a picker, a text field, and an icon.

17. A non-transitory computer-readable recording medium having recorded thereon instructions executable by at least one processor to cause the at least one processor to perform a method comprising:
presenting, to a user, a first graphical user interface (GUI) comprising information of a functional component, wherein the functional component is comprised of one or more sub-components;
receiving, from the user via the first GUI, a user input for managing a property associated with the one or more sub-components;
managing the property associated with the one or more sub-components based on the user input; and
updating the functional component based on the property.

18. The non-transitory computer-readable recording medium as claimed in claim 17, wherein the presenting the first GUI comprises:
obtaining at least one source design charter associated with the functional component;
generating, based on the at least one design charter, a listing of properties including at least one property associated with the one or more sub-components predefined by the source design charter;
generate, based on the listing of properties, the first GUI; and
provide the first GUI to a user terminal associated with the user.

19. The non-transitory computer-readable recording medium as claimed in claim 17, wherein the first GUI comprises a plurality of interactive elements, each of which is associated with an operation for managing the functional component, wherein the user input comprises a user interaction with at least one interactive element of the plurality of interactive elements, and wherein managing the functional component comprises:
determining, based on the user input, the operation associated with the interactive element with which the user has interacted; and
performing the operation to manage the functional component.

20. The non-transitory computer-readable recording medium as claimed in claim 19, wherein managing the functional component comprises:
based on determining that the operation is a creation of a new customized property associated with the one or more sub-components, present, to the user, a second GUI comprising one or more interactive elements for specifying the configuration of the new customized property associated with the one or more sub-components;
receive, from the user via the second GUI, a user interaction with the one or more interactive elements;
generate, based on the user interaction, a new customized design charter, wherein the new customized design charter defines the user-specified configuration of the new customized property associated with the one or more sub-components;
update, based on the new customized design charter, the first GUI to include information associated with the new customized property associated with the one or more sub-components; and
update, based on the new customized design charter, the first GUI to include information associated with the functional component as a result of the new customized property associated with the one or more sub-components.
